(19) United States
(12) Patent Application Publication
(10) Pub. No.: US 2024/0380129 A1
(43) Pub. Date: Nov. 14, 2024

(54) Four Polarization Antenna Arrangement

(71) Applicant: Matsing, Inc., Irvine, CA (US)

(72) Inventors: John Stewart Wilson, San Clemente, CA (US); Serguei Matitsine, Dallas, TX (US)

(21) Appl. No.: 18/657,093

(22) Filed: May 7, 2024

Related U.S. Application Data
(60) Provisional application No. 63/466,241, filed on May 12, 2023.

(51) Int. Cl. H01Q 21/24; H01Q 15/02; H04B 7/10

(52) U.S. Cl. CPC H01Q 21/245; H01Q 15/02; H04B 7/10

(57) ABSTRACT

An antenna assembly has four RF elements, each having a first configured for a first polarization, and a second port configured for a second polarization. An RF network connects to the eight RF element ports with four output ports providing two sets of orthogonal polarizations. The four outputs can be used for 4×4 MIMO. One embodiment uses the arrangement to feed an RF lens antenna.

### FIELD OF THE INVENTION

The field of the invention is wireless antennas.

### BACKGROUND

Major improvement in wireless communication performance has occurred in recent years with the implementation of various forms of multiple input multiple output (MIMO). Wireless antennas including base station antennas, wi-fi router antennas, and antennas embedded in devices such as smart phones and tablets use MIMO. Initially 2×2 MIMO was implemented with two antenna ports often using dual polarized antennas. Many dual polarized antennas are designed to produce very similar patterns to both polarizations. Typically, 4×4 MIMO is implemented by placing two dual polarized antennas some distance apart to create a combination of polarization diversity and spatial diversity. Diversity in this context refers to two signals producing different fading characteristics.

There are situations where 4×4 MIMO is desired but there is no room or there are disadvantages to having a second dual polarized antenna for spatial diversity. It is desirable for a 4×4 MIMO antenna to provide the same pattern coverage for all four ports. When the two sets of ports of dual polarized antenna are spatially separated this can be a challenge. A new approach to processing 4×4 MIMO using four polarizations is desirable.

Using a single antenna arrangement with four polarizations has two potential disadvantages. First, any impinging electromagnetic field can only be decomposed into two orthogonal polarizations to achieve maximum received efficiency. By decomposing into four polarizations approximately a 3 dB (or half the impinging power in the electromagnetic field) will be lost into each polarization compared to an equivalent antenna with two polarizations. This may be acceptable in situations where the additional size requirement for the two additional polarizations is not practical or where minimum size is important (for example in handheld devices). The second disadvantage is in receiving and processing the four signals for 4×4 MIMO. MIMO works because the signal received into the different antenna ports is uncorrelated enough to create separate channels of information. 2×2 MIMO using a single dual polarized antenna works because the received signal is randomly polarized due to scattering, multi-path, and diffraction of the transmitted signal such that typically two sufficiently uncorrelated signals are received. Traditional 4×4 MIMO adds a level of spatial diversity. If instead a single antenna with eight ports providing a level of spatial diversity between the four sets of ports is processed to produce four polarizations, it may be possible to achieve an acceptable level of MIMO gain for a given system scenario comparable to traditional 4×4 MIMO.

### SUMMARY OF THE INVENTION

The following description includes information that may be useful in understanding the present invention. It is not an admission that any of the information provided herein is prior art or relevant to the presently claimed invention, or that any publication specifically or implicitly referenced is prior art.

The invention here describes a technique to create a four port antenna that uses four polarizations. The concept is illustrated in FIG. 1. The arrangement consists of four dual polarized radiators, they can be of any two orthogonal polarization; vertical and horizontal, plus and minus 45 degree slant, or left hand and right hand circular. Two elliptical polarizations could be used as long as a high level of orthogonality—similar to traditional dual polarized antennas—can be achieved. Whichever polarization is chosen for the four elements—assuming one the common polarizations—the other two types of common polarizations will result from the arrangement. The example shown in FIG. 1 the two polarizations of the individual elements are plus 45 degree slant and minus 45 degree slant.

### BRIEF DESCRIPTION OF THE DRAWINGS

FIG. 1 is a diagram of a four port antenna that uses four polarizations.

FIG. 2 is a diagram showing an arrangement of RF devices integrated into a single printed circuit board.

FIG. 3A is a diagram depicting a four antenna arrangement used as a feed for an RF lens.

FIG. 3B is a diagram depicting the back of the feed arrangement of FIG. 3A.

FIG. 4A is a diagram depicting higher frequency elements (designed for 3.3 to 4.2 GHz) embedded in a dielectric block of dielectric constant 3.0.

FIG. 4B is a diagram showing the back of the feed arrangement of FIG. 4a and the port numbers.

### DETAILED DESCRIPTION

In FIG. 1 the four elements have ports of −45 degree slant polarization as indicated by ports 1, 2, 3, and 4, and the four elements have ports of +45 degree slant polarization as indicated by ports 5, 6, 7, and 8. Using simple vector addition it is seen that vertical polarization (v-pol) is produced by combining ports 2, 3, 5, and 8, horizontal polarization (h-pol) is produced by combining ports 2, and 3, then subtracting (equivalent to 180 degree phase adjustment) ports 5 and 8. In a similar fashion right hand circular polarization (RHCP) is produced by combining ports 1, and 4, then adding ports 6, and 7, but with a 90 degree phase to these ports relative to ports 1, and 4. Finally left hand circular polarization (LHCP) is produced by combining ports 1, and 4, then adding ports 6, and 7, but with a −90 degree phase to these ports relative to ports 1, and 4. The reverse scenario is equivalent. If ports 2, 3, 5, and 8, are replaced with ports 1, 4, 6, and 7, and ports 1, 4, 6, and 7, are replaced with ports 2, 3, 5, and 8 the arrangement still results in the same four polarizations.

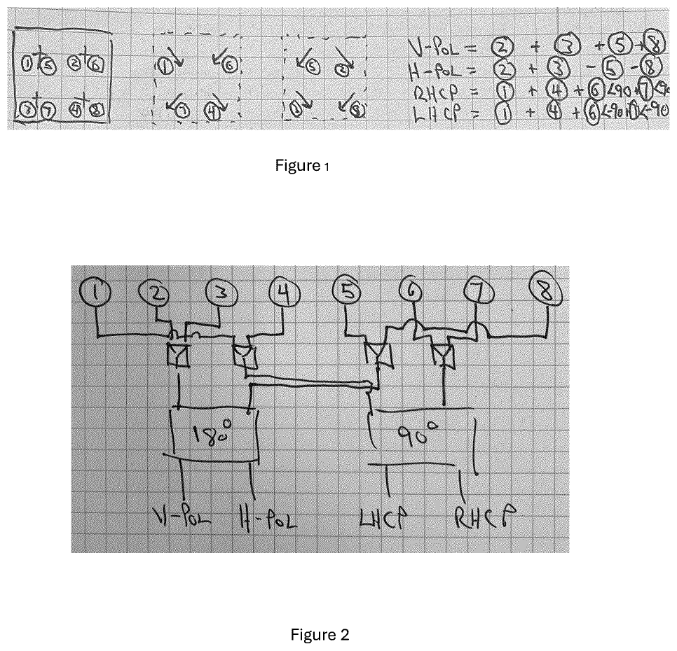

FIG. 2 shows how the arrangement can be realized using simple well known RF devices that can be stand alone connectorized devices or all elements can be integrated into a single printed circuit board. The bill of material (BOM) for the circuit consists of 8 phase matched RF cables between the element ports and the power dividers, 4 power dividers, 4 phase matched cables between the power dividers and the hybrids, 1 180 degree hybrid and 1 90 degree hybrid. Ports 2, 3, 5, and 8 are used to create vertical and horizontal polarization. Ports 2, and 3 are combined using a power combiner/divider, and ports 5, and 8 are combined using a power combiner/divider. The two sets of combined signals are then attached to the output ports of a 180 degree hybrid. This hybrid has the characteristic that one input outputs two signals with 0 degree phase change compared to the equivalent path length and the other input outputs two signals where one is at 0 degrees phase and the other is 180 degrees phase.

FIG. 2 also shows how the two circular polarizations are produced using ports 1, 4, 6, and 7. Ports 1, and 4 are combined using a power combiner/divider, and ports 6, and 7 are combined using a power combiner/divider. The two sets of combined signals then attached to the output ports of a 90 degree hybrid. This hybrid has the characteristic that two signals are input and the two output signals are the same power one is −90 degrees relative to an equivalent divider of same path length and the other is +90 degrees relative to an equivalent divider of same path length.

A preferred embodiment of the inventive subject matter is depicted above. The four elements can be of any dual polarized type; dipoles, flared slots, spirals, slots, patch, aperture coupled patch, log periodic, horn, open ended waveguide, dielectric rod, folded dipole, and annular slots to name just a few possibilities. The size of the elements relative to wavelength and the distance between elements is not critical, in the initial embodiment shown here the antennas are dual polarized dipoles of approximately 0.35 wavelength square and approximately 0.5 wavelength in spacing.

The arrangement provides eight separate ports where no two ports occur at the same location or have the same polarization, so the MIMO requirement of spatial and/or polarization diversity for each port is met. The arrangement can be applied to a wide variety of antenna products including base station antennas, wi-fi router antennas, and hand held device antennas. When the arrangement is used as a feed for an RF lens antenna there is an added performance benefit of stable directivity and pattern shape across a wide bandwidth due to the feed pattern narrowing at higher frequencies.

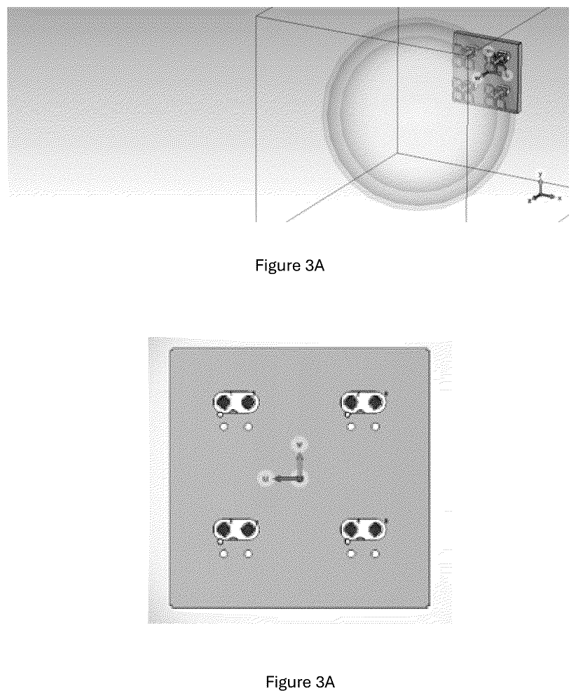

FIG. 3A demonstrates one possible embodiment of the invention. Here the four antenna arrangement is used as a feed for an RF lens. When feeding an RF lens the arrangement has the additional benefit of providing nearly constant directivity and pattern shape over a wide frequency band. FIG. 3B shows the back of the feed arrangement and the port numbers.

An important design tradeoff is the spacing between elements. If the spacing is too far the pattern deteriorates where the main beam distorts and bifurcates. However, if the elements are too close the isolation between elements deteriorates significantly. Also, cross-polarization levels deteriorate rapidly as the element spacing increases due to the vector subtraction nature of the approach. A way to improve these conditions is to dielectrically load the area around the four elements.

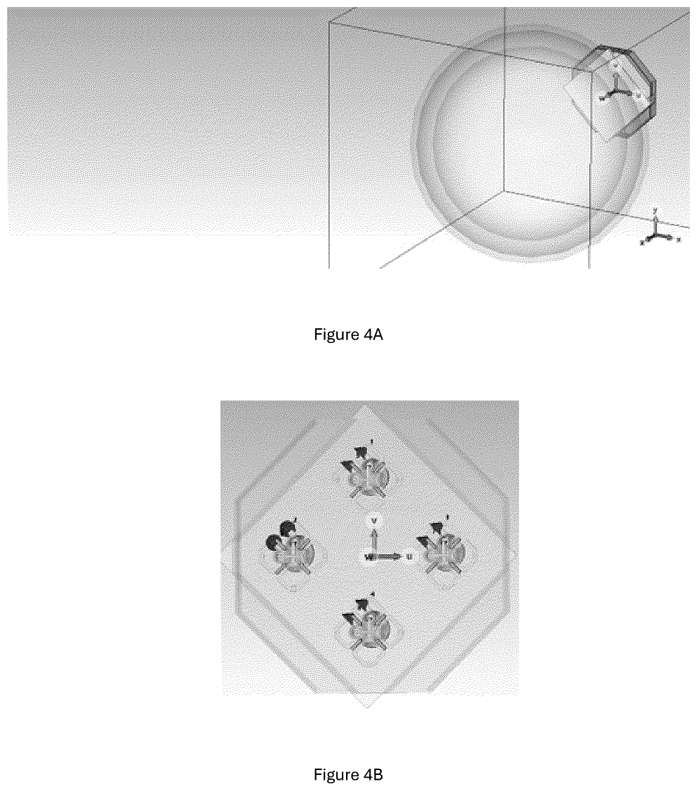

FIG. 4A a shows higher frequency elements (designed for 3.3 to 4.2 GHZ) embedded in a dielectric block of dielectric constant 3.0. This provides an acceptable tradeoff over a large band width between good pattern performance—including low cross-polarization—and isolation.

FIG. 4B is a diagram showing the back of the feed arrangement of FIG. 4a and the port numbers.

Isolation is a limiting specification so various techniques for improving isolation can be utilized including parasitic rods, walls between elements with de-absorbing materials, and symmetric use of anisotropic materials.

What is claimed is:

1. An antenna assembly comprising:
a first RF element, a second RF element, a third RF element, and a fourth RF element;
wherein each RF element further comprises a first port and a second port;
wherein the first port of each RF element is configured for a first polarization, and the second port of each RF element is configured for a second polarization; and
an RF network connected to the eight RF element ports with four output ports providing two sets of orthogonal polarizations.

2. The antenna assembly of claim 1, wherein the first polarization is least one of a 45+ slanted polarization, 45-slanted polarization, an elliptical polarization, and an orthogonal polarization.

3. The antenna assembly of claim 1, wherein the first polarization set is at least one of a vertical polarization, a horizontal polarization, a left hand circular polarization, and a right hand polarization.

4. The antenna assembly of claim 1, wherein the first polarization is configured to be orthogonal to the second polarization.

5. The antenna assembly of claim 1, wherein the first polarization is different from the second polarization.

6. The antenna assembly of claim 1, further comprising a lens;
wherein the lens is coupled to at least the first RF element, the second RF element, the third RF element, and the fourth RF element;
wherein the power divider is coupled to at least the third RF element and the fourth RF element, and configured for a second polarization set; and
wherein the third RF element and the fourth RF element are configured to produce a second beam pattern as a function of the second polarization set.

7. The communication system of claim 6, wherein the second beam pattern differs from the second beam pattern in at least one of a vertical and a horizontal beamwidth.
